(19) United States
(12) Patent Application Publication
(10) Pub. No.: US 2008/0169323 A1
(43) Pub. Date: Jul. 17, 2008

(54) Golf Bag Attachment Apparatus for Motorcycles

(76) Inventor: Lawrence L. Deitrich, New Cumberland, PA (US)

Correspondence Address: LAW OFFICES OF DUANE P. STONE, P.C., 8 N. BALTIMORE ST., DILLSBURG, PA, 17019, US

(21) Appl. No.: 11/622,486

(22) Filed: Jan. 12, 2007

(51) Int. Cl. B62J 7/04

(52) U.S. Cl. 224/413

(57) ABSTRACT

An apparatus for carrying a golf bag on a motorcycle is disclosed. The apparatus hereby satisfies the need of motorcycle enthusiasts to include their interest of golf with motorcycling, and which provides a balanced, easily mountable carrier for a golf bag that does not modify the motorcycle in an unsafe fashion. This apparatus is mounted directly into pre-existing rear side quick release bracket system (typically found on Harley Davidson Motorcycles) and will extend perpendicularly upward from each bracket to a given height above the rear fender. The golf bag will then rest on a secure mounting area. This apparatus will ensure the golf bag is situated in a balanced setting, along the motorcycle longitudinal centerline. This ensures a safe, comfortable ride for the cyclist.

### CROSS REFERENCE TO RELATED APPLICATIONS

This non-provisional application claims the benefit of U.S. Provisional Application No. 60/765,9383, filed Jan. 17, 2006.

### FEDERALLY SPONSORED RESEARCH

Not Applicable.

### SEQUENCE LISTING OR PROGRAM

Not Applicable.

### BACKGROUND

Two ever-growing and popular hobbies for adults in America are motorcycle riding and golfing. There are many organized gatherings of motorcycle riders across the United States on an annual basis. These events draw hundreds of thousands of riders from all corners of the country. Many of the riders that own motorcycles or frequent these events are also avid golfers. The need has arisen for a device that will combine these two hobbies in a safe and convenient way.

Additionally, safety is a primary concern when attaching any foreign device to a motorcycle because of the inherent instability found with any motorcycle. A permanent modification in the design of the motorcycle may cause an unanticipated safety risk. Therefore, when attempting to transport a golf bag on a motorcycle, the rider will want to attach the golf bag in such a way as will not permanently modify the motorcycle, potentially creating an unforeseen safety concern.

A big concern with attaching anything to a motorcycle is that by doing so, the center of gravity of the motorcycle will shift to one side or the other depending upon where the attachment is affixed. It is critical that any attachment be properly centered and securely fastened to avoid this shift in the center of gravity. Therefore, the need has arisen for a safe, rider-friendly golf bag attachment device that joins to pre-existing motorcycle attachments.

Information relevant to attempts to address these problems can be found in U.S. Pat. Nos. 6,401,998, 6,619,522, 6,938,806 and 6,698,635. However, each one of these references suffers from one or more of the following disadvantages: (1) creating a center of gravity that results in an unbalanced motorcycle which may lead to accidents and unsteady movement, (2) modifies the motorcycle in a fashion that may create an unsafe riding condition, and (3) creates a golf bag attachment which is not easily mounted or easily dismounted from the motorcycle.

For the foregoing reasons, there is a need for a safer and more easily attached and dismounted golf bag attachment apparatus for all those enthusiasts of motorcycle riding and golfing.

### SUMMARY

The present invention is directed to an apparatus that satisfies this need of motorcycle enthusiasts to include their interest of golf with cycling, and which provides a balanced, easily mountable carrier for a golf bag and does not modify the motorcycle in an unsafe fashion. A golf bag attachment apparatus having features of the present invention attaches along the motorcycle longitudinal centerline and comprises two vertical support legs, a means for joining the two vertical support legs, a vertical support member, a center rod, a base plate, a two semi-circular support members, a means securing the golf bag to the apparatus, and a means for covering the end of the center rod.

Each vertical support leg is constructed and oriented in a bilateral symmetric form and will be constructed in such a fashion as to be inserted into the pre-existing rear side quick release bracket system (typically found on Harley Davidson Motorcycles) and will extend perpendicularly upward from each bracket to a given height above the rear fender. The best mode defines the length of the two vertical support legs to be approximately 16 inches. Additionally, as shown in FIG. 6, a means for securing the two vertical support legs within the pre-existing rear side quick release bracket system may be included, which would traditionally include a screw or bolting means.

Furthermore, a means may be included that will connect the two vertical support legs and provide stability to the apparatus. Said means may either be of a fixed length, or able to be varied in length such that the two vertical support legs can fit onto any width of rear motorcycle fender and yet maintain adequate stability.

A vertical support member may then be included and will be affixed on or around the middle of the aforementioned means for securing the two vertical support legs and thusly affixed flush against or approximately flush against the bottom edge of this means. This vertical support member will extend upward to adjoin a center rod at a height sufficient to provide stability to the mounted golf bag and clearance of the bag with the rider's head. The best mode defines the length of the vertical support member to be approximately eight (8) inches.

The center rod will be affixed at approximately the center of its length to the vertical support member and at an angle generally sufficient to allow stability of the golf bag and ensure clearance of the golf bag with the rider's head, oriented in a fashion whereby the lower end is towards the rear end of the motorcycle. The best mode disclosed herein affixes these two members at an angle of approximately 45 degrees, though this angle is in no way intended to be limiting upon the scope of the appended claims. The best mode defines the length of the center rod at or approximately 36 inches.

A combination of elements may be used to securely affix any sized golf bag to the apparatus and center rod. Such combination may include a base plate, semi-circular support members, and a means for securely fastening the golf bag to the apparatus. As shown in FIG. 5, a base plate may be mounted perpendicularly on the lower end of the center rod and will be the part upon which the golf bag will rest. Disclaimed as the best mode, two semi-circular support members are affixed to the center rod in a fashion to provide stability to the golf bag resting thereon. To provide maximum stability to the golf bag held within the apparatus, one semi-circular support member may be placed on or approximate at the center point of the upper half of the center rod. Similarly, the second semi-circular support member contained in the best mode may be placed on or approximately at the center point of the lower half of the center rod. Finally, a means for securely fastening golf bag to golf bag attachment apparatus nearby or approximately nearby to the upper and lower semi-circular support members while golf bag rests upon base plate may be included. Finally, a means for protecting and covering upper end of center rod may be used to protect the apparatus from damage.

### BRIEF DESCRIPTION OF THE DRAWINGS

The drawings presented hereafter are to be used together with the description and appended claims to explain the inventive aspects of the invention, and representative examples of the embodiments herein. The drawings are not to be construed as limiting the invention to only the illustrated and described embodiments.

FIG. 1 is a perspective view of the carrier showing the invention carrying a golf bag attached to a motorcycle.

FIG. 2 is an elevation side view of the carrier showing the invention carrying a golf bag attached to a motorcycle.

FIG. 3 is a perspective view of the carrier mounted on a motorcycle.

FIG. 4 is a rear elevation view of the carrier mounted on a motorcycle with a golf bag attached therein.

FIG. 5 is an enlarged elevation side view of the lower base, lower semi-circular support member, and lower attachment strap with a golf bag mounted therein.

FIG. 6 is an enlarged view of the rear mounting bracket for a Harley Davidson motorcycle, with the invention installed.

### REFERENCE NUMERALS IN DRAWINGS

12 Golf Bag
14 Motorcycle
16 Rear wheel
18 Rear fender
20 Left rear side quick release bracket
22 Right rear side quick release bracket
24 Quick release screws
26 Left support leg
28 Right support leg
30 Horizontal support member
32 Vertical support member
34 Center rod
36 Base plate
38 Lower semi-circular support
40 Lower attachment strap
42 Upper attachment strap
44 Upper semi-circular support
46 Rubber rod end protector
48 Clips

### DESCRIPTION

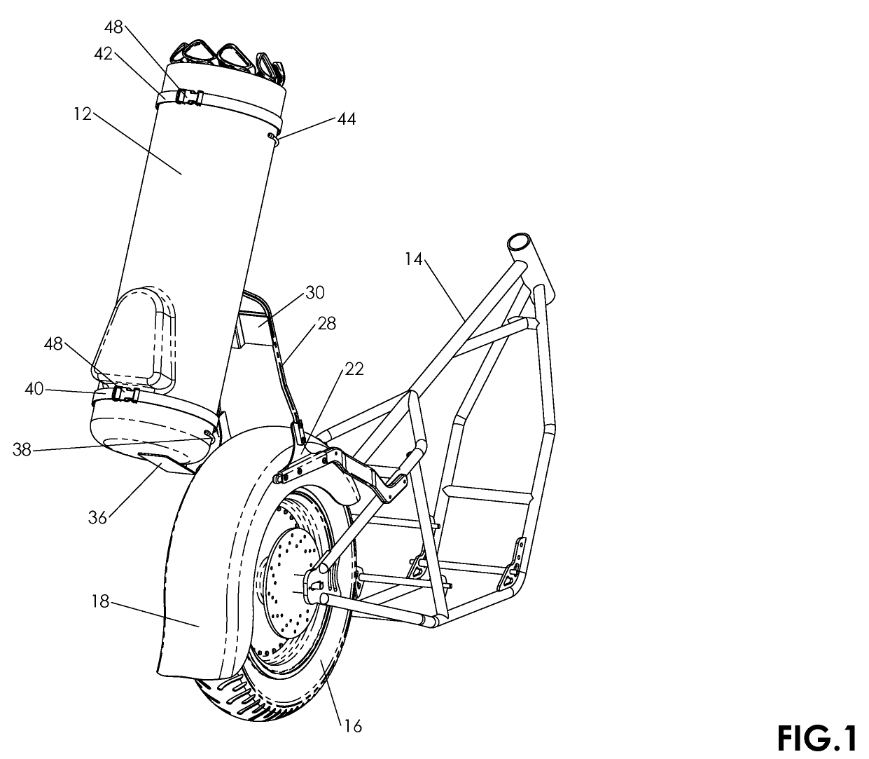

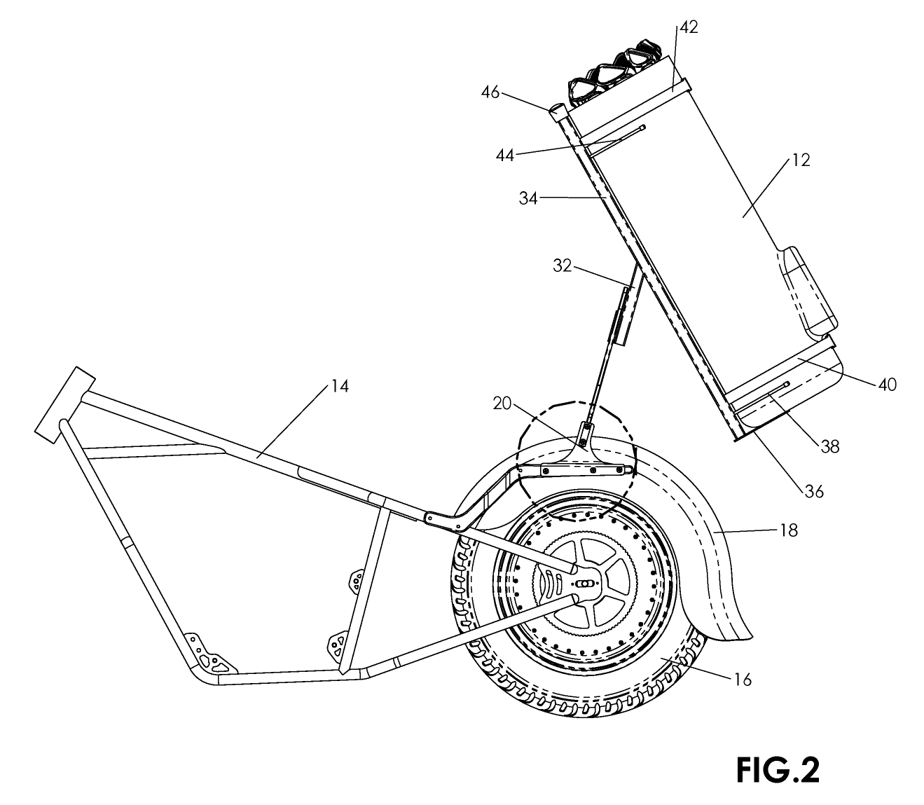

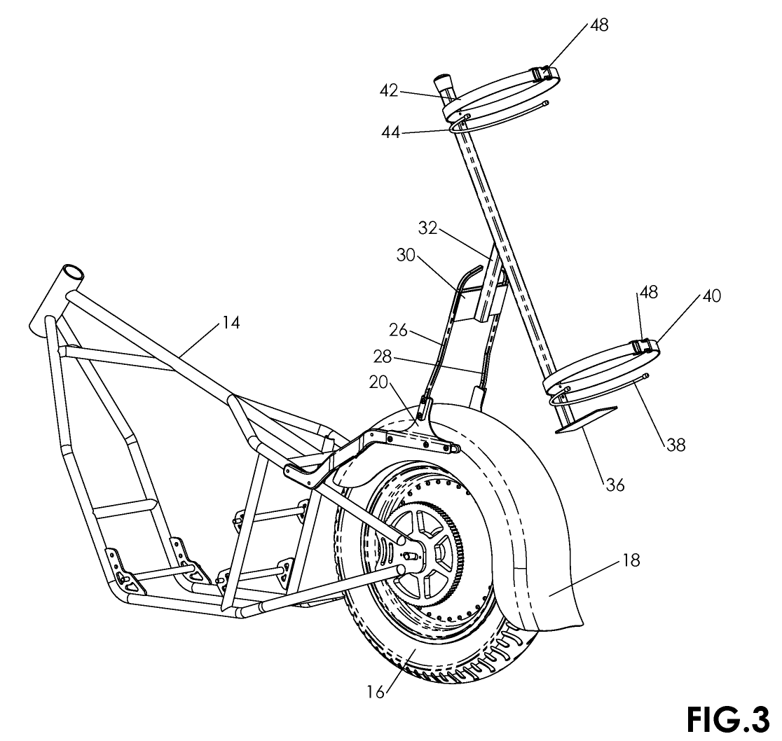

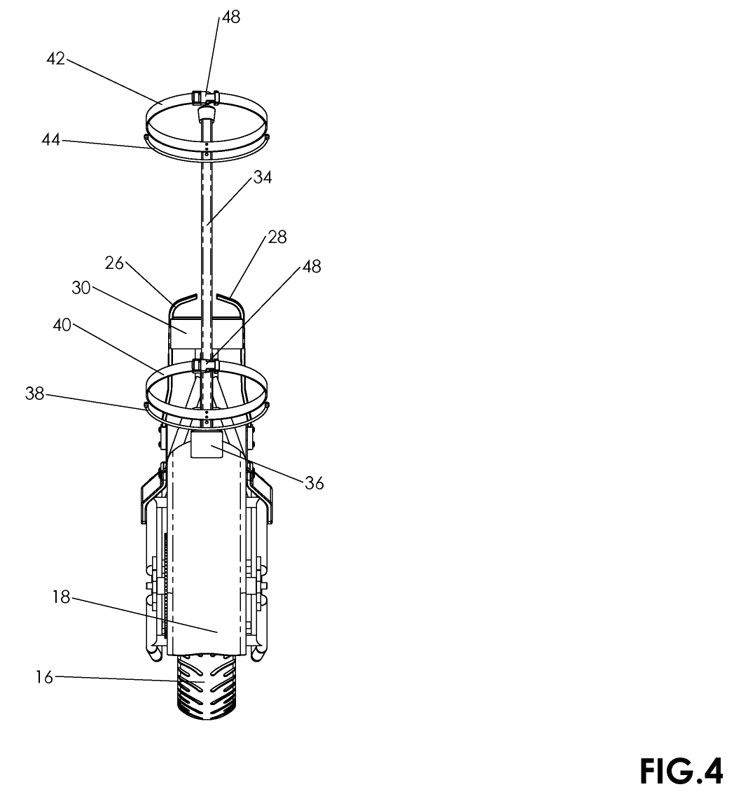

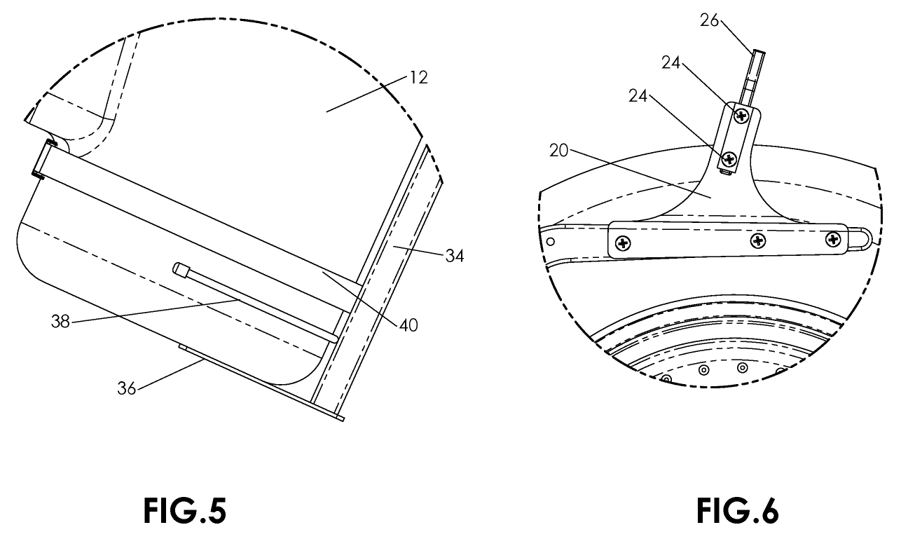

FIGS. 1, 2 show the golf bag attachment apparatus attached to a motorcycle 14 with a golf bag in place. For easier viewing, FIGS. 3, 4 are included to show the motorcycle golf bag attachment apparatus attached to the motorcycle 14 without a golf bag therein. The motorcycle 14 is equipped with a Harley Davidson quick release bracket system 20, 22. A golf bag attachment apparatus having features of the present invention which attaches along the motorcycle longitudinal centerline comprises: two vertical support legs 26, 28, a means for joining the two vertical support legs 30, a vertical support member 32, a center rod 34, a base plate 36, a two semi-circular support members 38, 44, a means securing the golf bag to the apparatus 40, 48, and a means for covering the end of the center rod 46. The invention is locked to said motorcycle 14 using the pre-existing Harley Davidson quick release brackets 20, 22 and pre-existing quick release screws 24. To attach the invention to the motorcycle 14 as shown in the FIGS. 1, 2, 3, 4 a left support leg 26 is lowered into the left quick release bracket 20 and secured by tightening the quick release screws 24. Similarly and simultaneously a right support leg 28 is lowered into the right quick release bracket 22 and secured by tightening the pre-existing quick release screws 24.

Each vertical support leg 26, 28 is constructed and oriented in a bilateral symmetric form which will place the golf bag 12 along the motorcycle's longitudinal centerline. This ensures that the golf bag 12 remains as balanced as possible while the motorcycle 14 is in motion, and thusly overcomes a significant deficiency in the prior art that has attempted to resolve this issue. The vertical support legs 26, 28 will be constructed from a square shaped tubular material that will ensure it is possible to be inserted into the pre-existing rear side quick release bracket system (typically found on Harley Davidson Motorcycles). Each vertical support leg will extend perpendicularly upward from each bracket to a given height above the rear fender. The best mode defines the length of the two vertical support legs 26, 28 to be approximately 16 inches. Additionally, a means for securing the two vertical support legs 26, 28 within the pre-existing rear side quick release bracket system may be included, which would traditionally include the pre-existing quick release screws 24.

Furthermore, a means may be included that will connect the two vertical support legs and provide stability to the apparatus. Said means may either be of a fixed length, or able to be varied in length such that the two vertical support legs 26, 28 can fit onto any width of rear motorcycle fender and yet maintain adequate stability. The best mode contemplates a fixed length for this structural member sufficient to adequately attach both vertical support legs, depending upon how those two vertical support legs are constructed. Each end of this horizontal connection means shall be properly and permanently affixed to the respective vertical support leg, typically affixed by a weld, or other connection means.

A vertical support member 32 may then be included and will be affixed on or around the middle of the aforementioned means for securing the two vertical support legs and thusly affixed flush against or approximately flush against the bottom edge of this means, typically affixed by a weld, or other connection means. This vertical support member 32 will extend upward to adjoin a center rod 34 at a height sufficient to provide stability to the mounted golf bag 12 and clearance of the bag with the rider's head. The best mode defines the length of the vertical support member 32 to be approximately eight (8) inches.

The center rod 34 will be affixed at approximately the center of its length to the vertical support member 32 and at an angle generally sufficient to allow stability of the golf bag 12 and ensure clearance of the golf bag 12 with the rider's head, oriented in a fashion whereby the lower end is towards the rear end of the motorcycle 14, typically affixed by a weld, or other connection means. The best mode disclosed herein affixes these two members at an angle of approximately 45 degrees, though this angle is in no way intended to be limiting upon the scope of the appended claims. The best mode defines the length of the center rod 34 at or approximately 36 inches.

A combination of a variety of elements may be used to securely affix any sized golf bag 12 to the apparatus and the center rod 34. Such combination may include a base plate 36, semi-circular support members, 38, 44 and a means for securely fastening the golf bag 12 to the apparatus. A base plate 36 may be mounted perpendicularly on the lower end of the center rod 34 and will be the part upon which the golf bag 12 will rest, typically affixed by a weld or other connection means. Disclaimed as the best mode, two semi-circular support members 38, 44 are affixed to the center rod 34 in a fashion to provide stability to the golf bag 12 resting thereon. To provide maximum stability to the golf bag 12 held within the apparatus, one semi-circular support member 44 may be placed on or approximate at the center point of the upper half of the center rod, typically affixed by a weld or other connection means. Similarly, the second semi-circular support member 38 contained in the best mode may be placed on or approximately at the center point of the lower half of the center rod 34, typically affixed by a weld or other connection means. Finally, a means for securely fastening golf bag 12 to golf bag attachment apparatus nearby or approximately nearby to the upper 44 and lower semi-circular support members 38 while golf bag rests upon base plate may be included. The best mode contemplates two flexible belts or straps to be mounted upon the center rod 34 via any connection means, such that one belt is mounted on the upper half of the center rod 34, and one belt is mounted on the lower half of the center rod 34. The belts or straps will then be equipped with any clipping or buckling means.

Finally, a means for protecting and covering upper end of center rod 34 may be used to protect the apparatus from damage. The best mode contemplates this element of the claimed apparatus as an off-the-shelf rubber or plastic pipe end cap or plug.

What is claimed is:

1. A golf bag attachment apparatus in combination with a motorcycle, the motorcycle being pre-equipped with rear side quick release bracket system, one bracket being located on each side in the upper area of the rear fender, said golf bag attachment apparatus comprising:
a. Two vertical support legs, a left support leg and a right support leg, constructed and oriented in a bilateral symmetric form, said left and right support legs will be inserted into the pre-existing rear side quick release bracket system and extend perpendicularly upward from each bracket to a given height above the rear fender;
b. Means for securing the two vertical support legs within the pre-existing rear side quick release bracket system;
c. Means for joining the two vertical support legs to provide stability, said means being one of the following:
i. Of a fixed length; or
ii. Able to allow for a variance of length to accommodate different motorcycle widths;
d. A vertical support member, said vertical support member having two ends, an upper end and a lower end, said lower end affixed (1) on or around the middle of the horizontal support member as measured on a horizontal scale, and (2) flush against or approximately flush against the bottom edge of the horizontal support member, and upper end extending upward to adjoin a center rod at a height sufficient to provide stability to the mounted golf bag and clearance of the bag with the rider's head;
e. A center rod, said center rod having two ends, an upper end and a lower end and being affixed at approximately the center of its length to the vertical support member and at an angle generally sufficient to allow stability of the golf bag and ensure clearance of the golf bag with the rider's head, oriented in a fashion whereby the lower end is towards the rear end of the motorcycle;
f. A base plate mounted perpendicularly on the lower end of the center rod, said base plate extending laterally upward to provide a stable base upon which the golf bag will rest;
g. A lower semi-circular support member affixed to said center rod at any location on or around the lower half of center rod;
h. An upper semi-circular support member affixed to said center rod at location on or around the upper half of center rod;
i. Means for securely fastening golf bag to golf bag attachment apparatus within the upper and lower semi-circular support members while golf bag rests upon base plate;
j. Means for protecting and covering upper end of center rod;

2. The apparatus in claim 1, wherein the two vertical support legs are of a length of approximately 16 inches.

3. The apparatus of claim 1, wherein the means for joining the two vertical support legs is a horizontal support member, said support member having two ends, a left end and a right end, said left end anchored to the left support leg and said right end anchored to the right support leg at such any given height that ensures adequate stability of the structure;

4. The apparatus of claim 3, wherein the horizontal support member's length can be varied to accommodate any fender width on any motorcycle.

5. The apparatus in claim 1, wherein the length of the vertical support member is approximately 8 inches.

6. The apparatus of claim 1, wherein the center rod is affixed to the vertical support member at an angle of approximately 45 degrees.

7. The apparatus of claim 6, wherein the center rod is affixed to the vertical support member at an angle of 45 degrees.

8. The apparatus in claim 1, wherein the center rod is of a length of approximately 36 inches.

9. The apparatus of claim 1, having a lower attachment strap of length sufficient to enclose golf bag on the golf bag apparatus affixed to center rod at any location on or around the lower half of center rod, said lower attachment strap comprised of any strip of textile-type material and of any sort of pre-existing means of closure;

10. The apparatus of claim 1, having an upper attachment strap of length sufficient to enclose golf bag on the golf bag attachment apparatus affixed to center rod at any location on or around the upper half of center rod, said upper attachment strap comprised of any strip of textile-type material and of any sort of pre-existing means of closure;

11. The apparatus of claim 1, wherein a rubber rod end protector is generally affixed to the upper end of the center rod, said rubber rod end protector composed of any material sufficient to protect rider's head and golf bag from the exposed upper end of the center rod.
